(19) United States
(12) Patent Application Publication
(10) Pub. No.: US 2006/0110308 A1
(43) Pub. Date: May 25, 2006

(54) Silicon carbides, silicon carbide based sorbents, and uses thereof

(76) Inventors: Puneet Gupta, Columbus, OH (US); Liang-Shih Fan, Columbus, OH (US)

Correspondence Address: DINSMORE & SHOHL LLP;One Dayton Centre, Suite 1300, One South Main Street, Dayton, OH, 45402-2023, US

(21) Appl. No.: 11/229,054

(22) Filed: Sep. 16, 2005

Related U.S. Application Data
(60) Provisional application No. 60/611,209, filed on Sep. 17, 2004.

(51) Int. Cl. C01B 31/36; B01D 53/52

(52) U.S. Cl. 423/345; 423/230

(57) ABSTRACT

Methods of making silicon carbide comprise providing at least one organosilicon precursor material, hydrolyzing the organosilicon in a solution comprising water and an acid catalyst, providing a surfactant to the solution, forming a gel by adding a base to the solution, and heating the gel at a temperature and for a time sufficient to produce silicon carbide.

### CROSS-REFERENCE TO RELATED APPLICATIONS

This application claims the benefit of U.S. Provisional Application Ser. No. 60/611,209 filed Sep. 17, 2004, and incorporates the application in its entirety.

### FIELD OF THE INVENTION

The present invention relates generally to methods of making silicon carbide, and specifically to methods of making sorbents comprising silicon carbide. These sorbents may be used to remove H₂S, SO₂, CO₂, and/or NOₓ from gas streams at high temperatures.

### BACKGROUND OF THE INVENTION

Silicon carbide (SiC) has unique mechanical and thermal properties that make it an ideal support for heterogeneous catalysts and metal oxide based gas-solid, gas-solid-solid reaction sorbents. At high temperatures, it is preferable to have sorbents, which facilitate fast reactions with the gas streams. With faster reactions, the reactor size may be reduced, in addition to the associated costs. Moreover, the larger surface area provides for easier regeneration of the sorbent. Sorbents with high surface area and large pores enable these fast reactions; however, SiC, especially SiC materials with high surface area and large pore volume, are difficult to produce.

Previous methods of making SiC have utilized acid catalyzed hydrolysis of an organosilicon precursor in solution, followed by the addition of weak base to form a gel; however, the resulting SiC materials produced contain insufficient surface area and porosity. As additional commercial applications, specifically in the areas of combustion/gasification of carbonaceous fuels such as coal, natural gas, oil, biomass, etc., are developed, the need arises for improved methods of making high surface area silicon carbide and sorbents comprising silicon carbide supports operable to remove impurities and/or pollutants from product gas streams.

### SUMMARY OF THE INVENTION

According to a first embodiment of the present invention, a method of making silicon carbide is provided. The method comprises providing at least one organosilicon precursor material, hydrolyzing the organosilicon in a solution comprising water and an acid catalyst, providing a surfactant to the solution, forming a gel by adding a base to the solution, and heating the gel at a temperature and for a time sufficient to produce silicon carbide.

According to a second embodiment of the present invention, another method of making silicon carbide is provided. The method comprises providing at least one organosilicon precursor material, hydrolyzing the organosilicon in a solution comprising water and an acid catalyst, forming a gel by adding a strong base to the solution, and heating the gel at a temperature and for a time sufficient to produce silicon carbide.

According to a third embodiment of the present invention, a method of making a sorbent is provided. The method comprises providing at least one organosilicon precursor material, hydrolyzing the organosilicon in a solution comprising water, and an acid catalyst, providing a surfactant to the solution, forming the gel by adding a base to the solution, heating the gel at a temperature and for a time sufficient to produce a silicon carbide support having mesopores and micropores, wherein the mesopores comprise a pore size of greater than 50 angstroms and the micropores comprise a pore size of less than about 50 angstroms. The method further comprises incorporating a metal-based material into the silicon carbide support to produce the sorbent.

According to a fourth embodiment, a sorbent is provided. The sorbent comprises a silicon carbide support having mesopores and micropores, wherein the mesopores comprise a pore size of greater than 50 angstroms and the micropores comprise a pore size of less than about 50 angstroms. The silicon carbide support comprises a surface area of 50 m²/g to about 700 m²/g. The sorbent further comprises a metal-based material incorporated onto a portion of the silicon carbide support, and a metal-based promoter also incorporated onto a portion of the silicon carbide support.

These and additional features and advantages provided by the embodiments of the present invention will be more fully understood in view of the following detailed description, and the appended claims.

### DETAILED DESCRIPTION

The embodiments of the present invention generally relate to methods of making silicon carbide, and specifically relate to methods of making and using sorbents comprising silicon carbide. The methods of making SiC may be described as a modified sol-gel procedure.

In one embodiment, a method of making silicon carbide is provided. The method comprises providing at least one organosilicon precursor material. The precursor may comprise at least one organosilane, for example, phenyltrimethoxysilane, (C₆H₅)(CH₃O)₃Si)). In further embodiments, the organosilicon may comprise at least one group with at least one double bond, for example, phenyl, vinyl, allyl, etc. attached to the silicon atom. Alkoxy groups may also be present in the organosilicon precursor to balance the charge on the Si atom.

The method further comprises hydrolyzing the organosilicon in a solution comprising water and an acid catalyst. In one embodiment, the acid catalyst may comprise an acid, preferably a strong acid such as HCl, HNO₃, H₂SO₄, etc. In another embodiment, a surfactant may be added to the solution. A surfactant, such as sodium dodecyl sulfate, cetyltrimethylammonium chloride (CTAC), etc., may be utilized to control the final pore structure of the silicon carbide. Optionally, a suitable polar solvent, such as methanol, ethanol, etc., may be added to the solution to aid in the mixing of the organosilicon precursor and aqueous phase (water), thereby aiding in subsequent gelation. Like the surfactant, the solvent may aid in the control of the final pore structure of the silicon carbide.

The method also comprises forming a gel by adding a base to the solution. The base may comprise a weak base such as NH₄OH. However, the use of a strong base may provide improved pore structure to the silicon carbide. A strong base defines a base that dissociates in water more easily. Due to this dissociation, a strong base may lead to almost instantaneous gelation, while a weak base may take longer, for example, 10 minutes or more, to form a gel. In one embodiment, the strong base comprises NaOH; however, other suitable strong bases such as KOH, Ca(OH)₂, etc. may also be used. Like the surfactant, a strong base also contributes to larger pores in the silicon carbide. The addition of a surfactant or strong base, individually or in combination, may produce large pores (mesopores) and may result in improved control over the final pore structure of the SiC.

The method further comprises heating the gel at a temperature and a time sufficient to produce silicon carbide. For example, the gel may be heated at a temperature from about 1200° C. to about 1800° C. for about 1 hour to about 5 hours. Typically, the gel is heated in a vacuum furnace. In further embodiments of the present method, the method comprises filtering the gel, for example, by drawing off any accumulated supernatant liquid and rinsing the gel in water, and/or drying the gel. Typically, the filtering and drying steps occur prior to heating, at which point, the heating step fires the gel to produce the silicon carbide.

The silicon carbide may comprise a pore volume of from about 0.35 cm³/g to about 0.50 cm³/g. The silicon carbide may comprise smaller micropores of 40 angstroms or less; however, the silicon carbide may also comprise larger mesopores having a pore size from about 50 to about 200 angstroms. The silicon carbide comprises a surface area of about 50 m²/g to about 700 m²/g. The SiC carbide may comprise numerous forms and sizes depending on the requirements of the reactor system in the respective industrial application, or field of use. For example, the SiC may be ground to a fine powder or cast during the gelation process or pelletized to form bigger particles greater than 0.5 mm.

The following examples illustrate methods of making silicon carbide in accordance with embodiments of the present invention:

### EXAMPLE 1

### Gel Formation: Use of Solvent

10 g of phenyltrimethoxysilane is taken in a 50 ml beaker with a magnetic stirrer. 2.23 g of water and 3.22 g Methanol are added. Stirring is started. 1 ml 1 M HCl is added to the beaker and then the beaker is covered with plastic film. After 30 min, 3 ml of 7.8M NH₄OH is added. On gel formation the supernatant liquid is drained off and the gel is rinsed with 10 ml water 5 times. The gel is dried at 0.41 atm absolute vacuum for 17 hours at 80° C.

### EXAMPLE 2

### Gel Formation: Use of Strong Base

10 g of phenyltrimethoxysilane is taken in a 50 ml beaker with a magnetic stirrer. 0.93 g of water and 1.63 g Methanol are added. Stirring is started. 1 ml 1 M HCl is added to the beaker and then the beaker is covered with plastic film. After 30 min, 3 ml of 0.5 M NaOH is added. Upon gel formation, the supernatant liquid is drained off and the gel is rinsed with 10 ml water 5 times. The gel is dried at 0.41 atm absolute vacuum for 17 hours at 80° C.

### EXAMPLE 3

### Gel Formation: Use of Surfactant

10 g of phenyltrimethoxysilane is provided to a 50 ml beaker with a magnetic stirrer. 2 g Sodium dodecyl sulfate, 3.52 g of water and 1.63 g Methanol are added. Stirring is started. 1 ml 1 M HCl is added to the beaker, and then the beaker is covered with plastic film. After 30 min, 3 ml of 0.5 M NH₄OH is added. Upon gel formation, the supernatant liquid is drained off, and the gel is rinsed with 10 ml water 5 times. The gel is then dried in a 0.41 atm vacuum for 17 hours at 80° C.

### EXAMPLE 4

### SiC Formation from the Gel: Vacuum Pyrolysis and Heating Rate

The dried gel is kept in a graphite crucible and fired in a vacuum furnace of 10⁻⁵ torr. The heating rate corresponds to 20° C./min until 700° C. is reached, 10° C./min until 1100° C. is reached, and 5° C./min until 1500° C. is reached. The gel is kept at 1500° C. for 2 hours.

In accordance with another embodiment of the present invention, a method of making a sorbent is provided. The method includes forming a silicon carbide support, by the methods of making silicon carbide described above. The silicon carbide comprises mesopores and micropores, wherein the mesopores comprise a pore size of greater than 50 angstroms and the micropores comprise a pore size of less than about 50 angstroms.

The method further comprises incorporating a metal-based material to the silicon carbide support to produce a sorbent. The metal-based material may be incorporated by any suitable method known to one of ordinary skill in the art. One such method is a wet impregnation procedure, which is described below.

### EXAMPLE 5

### Wet Impregnation Procedure

One gram of a SiC support is provided having a total pore volume of about 0.38 cm³/g and a micropore (<50 angstroms) volume 0.27 cm³/g. The desired sorbent sought to be produced comprises a composition of 20% by wt. Fe₂O₃ (metal-based material), 1% by wt. TiO₂, and 79% by wt. SiC (sorbent support). To produce the sorbent, a 0.216 g/ml solution of titanium-isopropoxide (TIP) in methanol is provided to the SiC support taken by adding 0.27 cc dropwise while stirring. The methanol is evaporated and SiC heated to 100° C. The procedure is repeated once again. This leaves TiO₂ in the micropores. Next, 0.322 g FeCl₃ per ml aqueous solution is prepared for impregnating Fe₂O₃. It is added to SiC with stirring 6 times 0.27 cc each with intermediate drying. The dry particles are then fired in an oxygen rich environment at 500° C. for 3 hours.

In one embodiment as illustrated in example 5, the metal-based material may be incorporated into the sorbent, such that the metal-based material may reside in at least a portion of the micropores of the silicon carbide support. The metal-based material may comprise any suitable metal known to one skilled in the art, such as elemental metals, alloys metal oxides, metal carbonates, metal sulfates, and combinations thereof. In a specific embodiment, metal oxides are incorporated into the SiC support.

In further embodiments, a stabilizer and/or a promoter may be provided to the sorbent. The stabilizer and the promoter may comprise any suitable metals or metal-based materials known to one skilled in the art. For example, the metals may be selected from Ti, Al, Si, Zr, Cr, Fe, Zn, Cu, V, Mn, Mo, Co, and Ca and combinations thereof. The stabilizer is used to enhance the durability of the sorbent, and the promoter is used to enhance the reactivity of the sorbent. It is contemplated that one metal-based material may be used as a promoter and stabilizer, or separate metal based promoters and stabilizers may be added. The weight percent of the metal-based material may vary between about 5 to about 50% by wt. of the sorbent, and the SiC support may comprise at least about 25% by wt. of the sorbent. The stabilizer, the promoter, or both in combination may comprise up to about 20% of the total sorbent weight.

The sorbent is configured to react with gas streams, and remove impurities or pollutants at high temperatures. Syn gas (also called coal gas, raw gas, etc.) produced by gasification/partial combustion of coal/biomass mainly consists of CO and H₂ and small amounts of CO₂ and steam. Sulfur is also usually present as H₂S that needs to be removed before further processing of syn gas. Other sulfur compounds formed in lower quantities include COS and CS₂. Depending upon the design of the gasifier and downstream configuration, the exit syn gas temperature is in the range of about 300 to about 1300° C.

Consequently, in accordance with one embodiment of the present invention, a method of removing H₂S from a gas stream is provided. The removal of other sulfur containing compounds, such as COS and CS₂ is further contemplated. The method comprises providing a sorbent produced by the above-described method, contacting the gas stream with the sorbent, allowing for the diffusion of H₂S in the gas stream through the mesopores of the silicon carbide support, and converting the H₂S to a metal sulfide by reacting the metal-based material of the sorbent with the gas stream. The gas may contact the sorbent in both a cocurrent (e.g. in a circulating fluidized bed reactor) or countercurrent (e.g. as in a moving bed of solids where solids move downwards while gas moves upwards or in a packed bed reactor which simulates counter-current operation) manner to suit the requirements of the process. In a further embodiment, the conversion occurs at a temperature effective to remove H₂S. The metal-based material, preferably a metal oxide, may react with H₂S at syn gas temperatures and may form the corresponding metal sulfide over a wide range of syn gas pressures (1-30 atm).

The general chemical reactions are shown below with MO denoting a metal oxide, M denoting an elemental metal, and MS denoting a metal sulfide:
MO+H₂S→MS+H₂O
M+H₂S→MS+H₂

Depending upon the desulfurization temperature, different metals and/or metal oxides can be used. For example, the metal-based material may comprise at least one of Fe, Zn, Cu, V, Mn, Mo, Co, Ca, and combinations thereof. For lower temperature applications, ranging from between 300 to about 500° C., Zn is a suitable metal. For temperatures ranging from between about 300 to about 600° C., Fe is more suitable. A combination of Fe and Zn may also be used. For higher temperature ranges of about 500 to about 900° C., Cu and Ca based sorbents are suitable. It is contemplated that other metals would be suitable in the above temperature ranges.

Under syn gas operating conditions, these metal oxides tend to partially or wholly reduce to their metallic form, which have either slower rates of reaction with H₂S, or are volatile as in the case of zinc. Hence, a stabilizer, as described above, may be used to prevent the metal oxide phase reducing to metallic form. The SiC support prevents sintering of such compounds, thereby leading to longer sorbent life.

Because the production of SiC, and the production of sorbents incorporating SiC supports may be costly, it is desirable to regenerate sorbents for multiple uses. In accordance with a further embodiment of the present invention, the metal-based material of the sorbent may be regenerated by reacting the metal sulfide with air to produce metal oxide and SO₂. The SO₂ is then reacted with unreacted metal sulfides to produce sulfur, which may be used to make sulfuric acid. The general reaction scheme is shown below:
MS+O₂→MO+SO₂
MS+SO₂→MO+S

Air is used for regeneration to return the sorbent to its original state. Sorbents with Fe based metals can be regenerated above about 400° C. Zn and Cu based sorbents may require a temperature above about 700° C. and above about 600° C., respectively, to be regenerated.

The sorbent may also be regenerated by reacting the metal sulfide with a combination of air and steam to produce metal oxides, H₂S, and SO₂. The general reactions are shown below.
MS+H₂O→MO+H₂S
MS+O₂→MO+SO₂

The H₂S further reacts with the SO₂ to produce elemental sulfur, as shown by the reaction below:
H₂S+SO₂→H₂O+S

By utilizing a reactor system with back mixing, for example, a dense phase fluidized bed reactor, higher sulfur recovery, i.e. 75% and greater, may be achieved. The following example illustrates the removal of H₂S using the sorbent of example 5.

### EXAMPLE 6

### H₂S Removal

The example 5 sorbent (20% Fe₂O₃, 1% TiO₂, 79% SiC) contacts a simulated syn gas stream generated from a bituminous coal slurry fed entrained flow oxygen fired gasifier. The gas composition of the syn gas stream is 41% CO, 30% H₂, 500 ppm H₂S, and H₂O in the ratios of 2.5, 5 and 10%, with the remainder comprising N₂. Tests conducted at 400, 500 and 600° C. demonstrate H₂S removal to below 20 ppm. This corresponds to greater than 99% sulfur capture from an actual syn gas system where the actual H₂S concentration may be as high as 11,000 ppm. Cyclic reaction-regeneration studies show no drop in activity for 16 cycles under varying operating conditions, and the sorbent is operable for extended number of cycles without any drop in activity.

In addition to removing H₂S, the sorbent may also be used to remove other gases, such as CO₂, SO₂, NOₓ, etc. In another embodiment, a method of removing CO₂ from a gas stream is provided. The method comprises providing a sorbent produced by the above-described methods, allowing the reactive gas species to diffuse through the mesopores of the silicon carbide support, and converting the CO₂ to a metal carbonate by reacting the metal-based material of the sorbent with the gas stream. Optionally, the conversion occurs at a temperature effective to remove CO₂. The metal-based materials used may comprise metals, alloys, metal oxides, metal carbonates, and combinations thereof. The metal bases may comprise Ca, Ba, Sr, Cd, Li, Mg, Mn, Ti, Zr, Ni, K, Zn, Co, or other suitable metals known to one of ordinary skill in the art.

The temperature for removing CO₂ varies depending on the metal-based material used in the sorbent. For example, a SiC supported CaO sorbent can be used at a temperature below about 750° C. during reaction with CO₂ (15%) in a flue gas stream (at atmospheric pressure) obtained from coal combustion. The sample reaction is demonstrated below:
CaO+CO₂→CaCO₃

Furthermore, the metal-based material of the sorbent may be regenerated by heating the metal carbonate to produce the metal-based material and CO₂, typically at a temperature higher than the temperature effective in removing CO₂. Optionally, the metal carbonate may be heated in a partial vacuum. For example, CaO can be regenerated according to the following chemical reaction by heating the sorbent to a temperature above 750° C. in a partial vacuum environment.
CaCO₃→CaO+CO₂

In another embodiment, the SiC sorbent may be used in a method of removing SO₂ from a gas stream. The method comprises providing a sorbent produced by the above-described method, allowing the reactive gas species to diffuse through the mesopores of the silicon carbide support; and converting the SO₂ to a metal sulfate by reacting the metal-based material of the sorbent with the gas stream in the presence of oxygen. Optionally, the SO₂ is converted at a temperature effective to remove SO₂.

Similar to the CO₂ removal method, the temperature effective in removing SO₂ may vary depending on the metal-based material used in the sorbent. To remove SO₂ from a gas mixture, the metal-based material may comprise a metallic/oxide/sulfate form of at least one of Bi, Ce, Co, Cr, Cu, Fe, Ni, Sn, Ti, Zn, Zr, and combinations thereof. For example, a sorbent comprising Fe₂O₃ reacts with SO₂ from a flue gas stream in the presence of O₂ below a temperature of 550° C. The reaction scheme is shown below
2Fe₂O₃+4SO2+O₂→4FeSO₄

The metal-based material of the sorbent may be regenerated by heating the metal sulfate to produce the metal-based material and SO₂ at a temperature above the temperature effective at removing SO₂. The heating may occur in a partial vacuum or in the presence of air. For example, FeSO₄ can be regenerated to Fe₂O₃ at a temperature above 480° C. In addition to removing impurities from a gas stream produced during traditional combustion processes, it is contemplated that the SiC based sorbent could also be used in other commercial and/or industrial applications. For instance, the SiC sorbent may be used in Chemical Looping Combustion (CLC). In CLC, hydrocarbon fuels may be converted to heat, which may be used for electricity. CLC may also be used to convert hydrocarbon fuels into hydrogen.

It is noted that terms like “specifically,” “preferably,” “generally”, “typically”, “often” and the like are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the spirit and scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of making silicon carbide comprising:
providing at least one organosilicon precursor material;
hydrolyzing the organosilicon in a solution comprising water and an acid catalyst;
providing a surfactant to the solution;
forming a gel by adding a base to the solution; and
heating the dried gel at a temperature and for a time sufficient to produce silicon carbide.

2. A method according to claim 1 wherein the base is a strong base.

3. A method according to claim 1 further comprising adding a solvent to the solution to aid in the mixing of the water and the organosilicon precursor.

4. A method according to claim 1 further comprising filtering and/or vacuum drying the gel.

5. A method according to claim 1 wherein the silicon carbide comprises a pore volume of from about 0.35 cm³/g to about 0.50 cm³/g.

6. A method according to claim 1 wherein the silicon carbide comprises mesopores having a pore size of about 50 to about 200 angstroms.

7. A method according to claim 1 wherein the silicon carbide comprises a surface area of about 50 m²/g to about 700 m²/g.

8. A method of making silicon carbide comprising:
providing at least one organosilicon precursor material;
hydrolyzing the organosilicon in a solution comprising water and an acid catalyst;
forming a gel by adding a strong base; and
heating the gel at a temperature and for a time sufficient to produce silicon carbide.

9. A method making a sorbent comprising:
providing at least one organosilicon precursor material;
hydrolyzing the organosilicon in a solution comprising water, and an acid catalyst;
providing a surfactant to the solution;
forming the gel by adding a base to the solution;
heating the gel at a temperature and for a time sufficient to produce a silicon carbide support having mesopores and micropores, wherein the mesopores comprise a pore size of greater than 50 angstroms and the micropores comprise a pore size of less than about 50 angstroms; and
incorporating a metal-based material into the silicon carbide support to produce the sorbent.

10. A method according to claim 9 wherein the silicon carbide comprises a surface area of about 50 m²/g to about 700 m²/g.

11. A method according to claim 9 further comprising providing a catalyst to the sorbent.

12. A method according to claim 9 further comprising providing a stabilizing agent to the sorbent.

13. A method according to claim 9 wherein the SiC support comprises at least about 25% by wt. of the sorbent

14. A method of removing H₂S from a gas stream comprising:
providing a sorbent as produced by claim 9;
contacting the gas stream with the sorbent; and
converting the H₂S to a metal sulfide by reacting the metal-based material of the sorbent with the gas stream.

15. A method according to claim 14 further comprising regenerating the metal-based material of the sorbent by reacting the metal sulfide with air to produce the metal-based material and SO₂.

16. A method according to claim 15 comprising further reacting SO₂ with unreacted metal sulfides to produce sulfur.

17. A method according to claim 16 further comprising regenerating the sorbent by reacting the metal sulfide with a combination of air and steam to produce metal oxides, H₂S, and SO₂.

18. A method according to claim 17 comprising further reacting the H₂S with SO₂ to produce steam and elemental sulfur.

19. A method of removing CO₂ from a gas stream comprising:
providing a sorbent as produced by claim 9;
contacting the gas stream with the sorbent; and
converting the CO₂ to a metal carbonate by reacting the metal-based material of the sorbent with the gas stream.

20. A method according to claim 19 further comprising regenerating the metal-based material of the sorbent by heating the metal carbonate to produce the metal-based material and CO₂.

21. A method of removing SO₂ from a gas stream comprising:
providing a sorbent as produced by claim 9;
contacting the gas stream to the sorbent; and
converting the SO₂ to a metal sulfate by reacting the metal-based material of the sorbent with oxygen.

22. A method according to claim 21 further comprising regenerating the metal-based material of the sorbent by heating the metal sulfate to produce the metal-based material and SO₂.

23. A sorbent comprising:
a silicon carbide support having mesopores and micropores, wherein the mesopores comprise a pore size of greater than 50 angstroms and the micropores comprise a pore size of less than about 50 angstroms, and the silicon carbide support comprises a surface area of 50 m²/g to about 700 m²/g;
a metal-based material incorporated onto a portion of the silicon carbide support; and
a metal-based promoter incorporated onto a portion of the silicon carbide support.

24. A sorbent according to claim 23 wherein the metal-based material resides in at least a portion of the micropores of the silicon carbide support.

25. A sorbent according to claim 23 wherein the metal-based promoter comprises an elemental metal or metal oxide selected from the group consisting of Ti, Al, Si, Zr, Cr, Fe, Zn, Cu. V, Mn, Mo, Co, and Ca and combinations thereof.

26. A sorbent according to claim 23 further comprising a metal-based stabilizer incorporated onto a portion of the silicon carbide support.
